(19) United States
(12) Patent Application Publication
(10) Pub. No.: US 2005/0102371 A1
(43) Pub. Date: May 12, 2005

(54) Streaming from a server to a client

(76) Inventor: Emre Aksu, Tampere (FI)

Correspondence Address: CRAWFORD MAUNU PLLC, 1270 NORTHLAND DRIVE, SUITE 390, ST. PAUL, MN, 55120, US

(21) Appl. No.: 10/704,357

(22) Filed: Nov. 7, 2003

(51) Int. Cl. G06F 15/16

(52) U.S. Cl. 709/217

(57) ABSTRACT

The invention relates to a method for arranging streaming or downloading a streamable file comprising meta-data and media-data over a network between a server and a client at least part of the meta-data of the file is transmitted to the client, the transmitted meta-data comprising at least locations of media-data ranges in the file. The location of the desired media-data part in the file is determined on the basis of the received meta-data. A request is sent to the server informing the server on the media-data range that is to be transferred to the client. The requested media-data range is then transmitted to the client.

### BACKGROUND OF THE INVENTION

The present invention relates to arranging streaming or downloading a streamable file from a server to a client.

Streaming refers to the ability of an application to play synchronized media streams, such as audio and video streams, on a continuous basis while those streams are being transmitted to the client over a data network. A multimedia streaming system consists of a streaming server and a number of clients (players), which access the server via a connection medium (possibly a network connection). The clients fetch either pre-stored or live multimedia content from the server and play it back substantially in real-time while the content is being downloaded. The overall multimedia presentation may be called a movie and can be logically divided into tracks. Each track represents a timed sequence of a single media type (frames of video, for example). Within each track, each timed unit is called a media sample.

Streaming systems can be divided into two categories based on server-side technology. These categories are herein referred to as normal streaming and progressive downloading. In normal streaming, servers employ application-level means to control the bit-rate of the transmitted stream. The target is to transmit the stream at a rate that is approximately equal to its playback rate. Some servers may adjust the contents of multimedia files on the fly to meet the available network bandwidth and to avoid network congestion. Reliable or unreliable transport protocols and networks can be used. If unreliable transport protocols are in use, normal streaming servers typically encapsulate the information residing in multimedia files into network transport packets. This can be done according to specific protocols and formats, typically using the RTP/UDP (Real Time transport Protocol/User Datagram Protocol) protocols and the RTP payload formats.

Progressive downloading, which can also be referred to as HTTP (Hypertext Transfer Protocol) streaming, HTTP fast-start, or pseudo-streaming, operates on top of a reliable transport protocol. Servers may not employ any application-level means to control the bit-rate of the transmitted stream. Instead, the servers may rely on the flow control mechanisms provided by the underlying reliable transport protocol. Reliable transport protocols are typically connection-oriented. For example, TCP (Transport Control Protocol) is used to control the transmitted bit-rate with a feedback-based algorithm. Consequently, applications do not have to encapsulate any data into transport packets, but multimedia files are transmitted as such in a pseudo-streaming system. Thus, the clients receive exact replicas of the files residing on the server side. This enables the file to be played multiple times without needing to stream the data again.

When creating content for multimedia streaming, each media sample is compressed using a specific compression method, resulting in a bit-stream conforming to a specific format. In addition to the media compression formats there must be a container format, a file format that associates the compressed media samples with each other, among other things. In addition, the file format may include information about indexing the file, hints how to encapsulate the media into transport packets, and data how to synchronize media tracks, for example. The media bit-streams can also be referred to as the media-data, whereas all the additional information in a multimedia container file can be referred to as the meta-data. The file format is called a streaming format if it can be streamed as such on top of a data pipe from a server to a client. Consequently, streaming formats interleave media tracks to a single file, and media data appears in decoding or playback order. Streaming formats must be used when the underlying network services do not provide a separate transmission channel for each media type. Streamable file formats contain information that the streaming server can easily utilize when streaming data. For example, the format may enable storing of multiple versions of media bit-streams targeted for different network bandwidths, and the streaming server can decide which bit-rate to use according to the connection between the client and the server. Streamable formats are seldom streamed as such, and therefore they can either be interleaved or contain links to separate media tracks.

QuickTime file format, ISO Base Media file format, MP4 file format from MPEG (Moving Picture Experts Group), 3GP file format from 3GPP (Third Generation Partnership Project) allow creation of pseudo-streamable files. In order to pseudo-streaming to work, these streamable files have to be created in a special manner. Firstly, the meta-data defining the characteristics of the media-data inside the file has to be at the beginning of the file. At least part of the meta-data, e.g. the file-level meta-data, has to be provided to the client in the beginning of the session in order to enable the client to receive media-data. Secondly, the media-data has to be present in the file in an interleaved manner. This means that the media-data has to be stored in the file in the timeline order e.g. as audio data, video data, audio data, video data, etc. Thirdly, the file has to be specifically marked in the meta-data as being pseudo-streamable.

### BRIEF DESCRIPTION OF THE INVENTION

An object of the invention is to provide a streaming arrangement enabling to avoid at least part of the above-mentioned restrictions. The object of the invention is achieved with a method, a system, a client, a telecommunications device, a server, and computer program product which are characterized by what is disclosed in the independent claims. Some preferred embodiments of the invention are set forth in the dependent claims.

According to an aspect of the invention, at least part of the meta-data of the file is transmitted to the client, the transmitted meta-data comprising at least locations of media-data ranges in the file. The location of the desired media-data part in the file is determined on the basis of the received meta-data. A request is sent to the server informing the server on the media-data range that is to be transferred to the client. The requested media-data range is then transmitted to the client.

Session between the client and the server refers to any logical relationship or connection between the client and the server for transferring a streamable file. The term file refers to any grouping of data comprising both meta-data and media-data possibly from plurality of media sources. The desired media-data can be determined e.g. based on user commands or presentation order information.

The aspects of the invention provide flexibility especially in terms of file formats and arrangement of streaming and provide advantages especially for multimedia content streaming. As the client knows the locations of the data ranges in the file, it is possible for the client to request basically any part of the file, independent of whether preceding part of a media-data range has or has not been streamed or downloaded. For instance, the user may mute the audio in which case the client may be arranged only to request video media-data of the file. The client can thus simply jump to a later or previous byte range if seek-forward or backward is performed by the user of the client. The invention also enables the client to use the available memory in an efficient manner such that the media-data retrieved need not be stored as a file. It can be utilized in a play-and-discard manner, i.e. as the parts of the media-data already played do not need to be retained. As regards file formation, the invention facilitates that the media-data can be in any order in the file, as the client is able to request separate ranges of media-data in the desired order.

### BRIEF DESCRIPTION OF THE DRAWINGS

In the following, the invention will be described in further detail by means of preferred embodiments and with reference to the accompanying drawings, in which

FIG. 1 is a block diagram illustrating a transmission system for multimedia content streaming;

FIG. 2 illustrates functions of a client according to an embodiment of the invention; and

FIG. 3 illustrates functions of a server according to an embodiment of the invention.

### DETAILED DESCRIPTION OF THE INVENTION

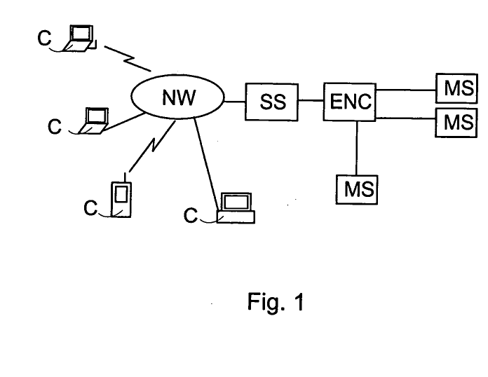

FIG. 1 illustrates a transmission system for multimedia content streaming. The system comprises an encoder ENC, which may also be referred to as an editor, preparing media content data for transmission typically from a plurality of media sources MS, a streaming server SS transmitting the encoded multimedia files over a network NW and a plurality of clients C receiving the files. The content may be from a recorder recording live presentation, e.g. a videocamera, or it may be previously stored on a storage device, such as a video tape, CD, DVD, hard disk etc. The content may be e.g. video, audio, still images and it may also comprise data files. The multimedia files from the encoder ENC are transmitted to the server SS. The server SS is able to serve a plurality of clients C and respond to client requests by transmitting multimedia files from a server database or immediately from the encoder ENC using unicast or multicast paths. The network NW may be e.g. a mobile communications network, a local area network, a broadcasting network or multiple different networks separated by gateways. It should be noted that although in FIG. 1 the content creation functions (by ENC) and the streaming functions (by SS) are separated, they may be done by the same device, or be carried out by more than two devices.

The following embodiments may be applied in any wireless and/or wired telecommunications system enabling streaming or downloading of streamable files. The underlying transmission layer may utilize circuit-switched or packet-switched data connections. One example of such communications network is the third generation mobile communication system being developed by the 3GPP. In the following embodiments it is assumed that HTTP protocol is applied for transferring at least parts of the streamable file. Besides HTTP/TCP, also other transport layer protocols may be used. For instance, FTP (File Transfer Protocol) or WTP (Wireless Transaction Protocol) of WAP (Wireless Application Protocol) suite may provide the transport functions.

Meta-data carried in a streamable file can be classified as follows. Typically the scope of a portion of meta-data is the entire file. Such meta-data may include an identification of media codecs in use or an indication of a correct display rectangle size. This kind of meta-data may be referred to as file-level meta-data (or presentation-level meta-data). Another portion of meta-data relates to specific media samples. Such meta-data may include an indication of sample type and size in bytes. Such meta-data may be referred to as sample-specific meta-data.

As media decoding and playback are typically not possible without file-level meta-data, such meta-data appears at the beginning of streaming files as a file header section. According to an embodiment, at least information determining the media-data offset locations is determined as file-level meta-data in the beginning of the file. Sample-specific meta-data may be interleaved with media-data or it can appear as an integral section at the beginning of a file immediately after or interleaved with file-level meta-data.

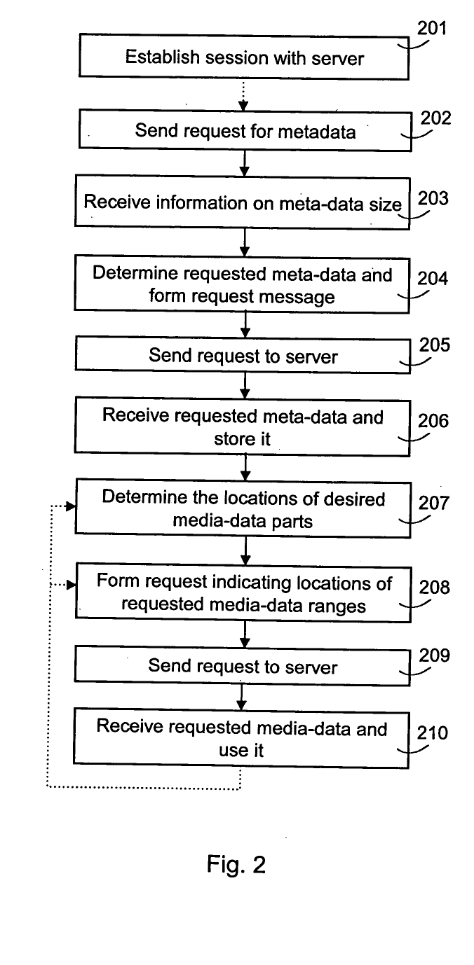

FIG. 2 illustrates the functions of a streaming client such as the client C in FIG. 1. In step 201 the client establishes a session with a server for streaming or downloading a streamable file. During this step transmission resources are reserved and a logical connection is established between the server and the client, e.g. via the network NW of FIG. 1. In step 202 the actual streaming or downloading is initiated when the client requests from the server at least the part of the file informing the size of the meta-data portion. This information is typically in the beginning of the file and naturally depends on the applied file format. As an example, in 3GP file format this information is specified by the 4 bytes preceding the “moov” box and when this file format is applied, the client is thus configured to request 202 and later on check 204 these 4 bits. Client informs the file in question e.g. by a URI (Uniform Resource Identifier). Client thus requests a specific part of the file by indicating the range or part of the file that includes this information.

In step 203 the client receives at least the part of the file informing the size of the meta-data. Based on this received information, the client determines the location of the meta-data part in the file and forms 204 a request for a specified meta-data range. The client may request for all meta-data or only part of it. This request is sent to the server in step 205.

In step 206 the client receives the meta-data and preferably stores it for the streaming or downloading session. The received meta-data comprising at least locations of media-data ranges in the file. These media-data ranges may vary depending on the applied file format; they e.g. determine only one media sample or a group of media samples such as a track and comprise of one or more media types. Based on this information the client is able to determine the byte offset locations of the media-data. When the client is aware of the locations of the different media-data ranges or parts, it may determine which media-data ranges are desired to be streamed or downloaded. This may involve prompting the user. Typically the already received meta-data comprises file-level display and/or decoding order information based on which the media-data ranges to be requested are determined. When the client is aware of the desired one or more media-data ranges, it determines 207 their locations in the file on the basis of the received location-specific meta-data. Then it forms 208 a request indicating the at least one media-data range that is to be transferred to the client, and sends 209 this request to the server. The media-data ranges may be specified in the request (and also in the meta-data) as byte range values, determining at least the first and the last byte values that are requested. Depending on the implementation and underlying transfer protocol, one or more media-data ranges may be specified.

As an example, when 3GP, ISO and MP4 file formats are applied, the locations of the media-data ranges or parts can be identified by the sample-to-chunk and chunk offset box present in the meta-data. By checking these information fields, the client can identify the byte ranges of each sample, relative to the beginning of the file. For more information on these fields and other parts of an ISO compliant file format, a reference is made to ISO/IEC JTC1/SC29/WG11 specification “ISO Media File format specification MP4 Technology under consideration for ISO/IEC 14496-1:2001 Amd 3”, 20 Jul. 2001. More specifically, Chapter 5.3 describes the box definitions.

In step 210 the client receives the requested media-data found in the range indicated in the request 208, 209. The media-data may then be used as appropriate, typically it is parsed and played (when enough media-data is received) for the user but it may as well be stored for later use. In one embodiment, the client C gets in step 210 a compressed and multiplexed multimedia file portions from the server SS. The client C parses and demultiplexes the portions in order to obtain separate media tracks. These media tracks are then decompressed to provide reconstructed media tracks which can then be played out using output devices of a user interface. In addition to these functions, a controller unit is provided in the client to incorporate end user actions, i.e. to control playback according to end user input and to handle client server-control. An independent media player application or a browser plug-in may provide the playback.

It is important to note that especially for streaming purposes it is very useful to request only relatively small parts of the media-data in the steps 208 and 209. Thus in one embodiment, the client is arranged to form and send requests consecutively for different parts of the presentation, e.g. in the decoding and displaying order in time. However, the order of requests for media-data parts may be different as the user may wish to skip some parts, for instance. Thus the client may be configured to return to step 207 or 208 based on a command from a user, after particular time limit, based on the status of the presentation of the file, or for some other criterion.

As already mentioned, the client is typically configured to determine the order of the media-data parts, i.e. which media-data are requested in step 208, on the basis of a display and decoding order information field present in the received meta-data. For example, in 3GP, ISO and MP4 file formats, time-to-sample atom makes a mapping from presentation time to the media samples. The client can be configured to use this information to understand the request order of samples, and use the byte location related meta-data to map the samples to byte ranges.

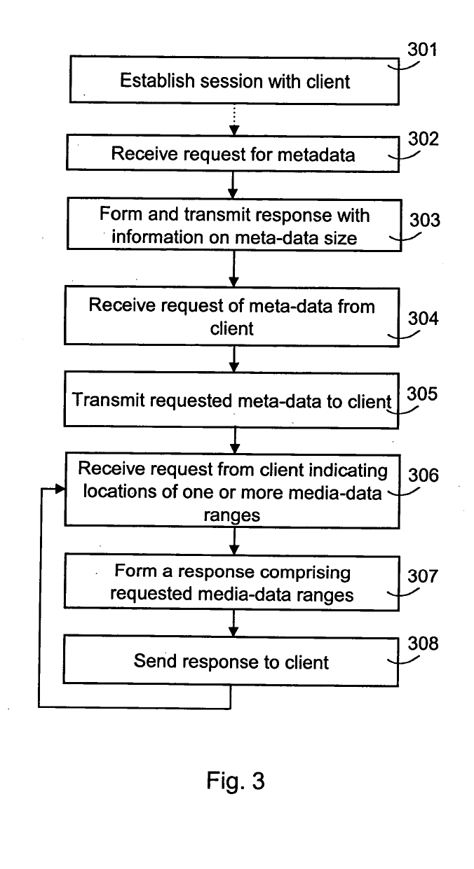

FIG. 3 illustrates the functions of a server transferring streamable file. The server in which the functions of FIG. 3 are applied may be a streaming server such as the SS in FIG. 1 but it may be any server capable of parsing and transferring streamable files on the basis of requests from clients. The file that is requested may be stored in the server device or it may access and/or download it from some other entity as a response to the request. In step 301 the server established a session with a client for streaming or downloading a streamable file. In step 302 the server receives a request from the client for at least the part of the file informing the size of the meta-data portion. Based on the indicated range, the server is configured to determine the contents of the range in the referred file, i.e. determine at least the value of the field determining the size of the meta-data portion. The server is configured to form 303 a response message comprising at least the part of the file informing the size of the meta-data, and to send it to the client.

In step 304 the server receives a request comprising an indication on the meta-data range that is to be transferred to the client. Similarly as described above, the server then determines the requested range of the file, and forms a response message, which is then sent 305 to the client.

In step 306 the server receives a request from the client indicating at least one media-data range that is to be transferred to the client. The server determines the requested at least one media-data range from the file and forms 307 a response comprising the requested media-data range. Then the server sends 308 the response to the client. As described above, the client may initiate many requests in which case step 306 is re-entered.

There are also other embodiments on how the inventive functionality may be carried out. In one embodiment, steps 202-206 and 302-303 are not necessary, but after step 201 the client simply starts the streaming or downloading by a request without any range or with a pre-determined (large) range. When it has received the meta-data portion describing the locations of the different media-data ranges or parts, e.g. the byte offset locations, it may enter the step 207.

The requests and responses may be transferred between the client and the server using any reliable transport protocol. One such protocol is the HTTP. The ranging feature of HTTP version 1.1 can according to an embodiment be used for the purposes of indicating the range of the meta-data and/or media-data that is requested, as illustrated above in connection with FIGS. 2 and 3. Thus, the client according to an embodiment is configured to form a HTTP GET request which comprises, in addition to the URI of the file and possibly some other information, one or more byte ranges of media-data/meta-data in the file in a byte range parameter. For more information on HTTP functionality, a reference is made to IETF RFC 2616, “Hypertext Transfer Protocol—HTTP/1.1”, June 1999. In particular, the usage of ranges is described in Chapters 3.12, 13.5.4, and 14.35.1. When the client is arranged to form the HTTP GET requests according to the HTTP specifications, any HTTP v. 1.1 compliant server can respond to the requests comprising one or more ranges. Thus, according to a preferred embodiment no changes are needed for HTTP servers. As described above, in one embodiment it is necessary to send consecutive requests for the media-data portions possibly with short time intervals. According to an embodiment, the HTTP pipelining technique is applied for this purpose. This technique enables the client to send a plurality of request without waiting for each response, allowing a single TCP connection to be used much more efficiently, with much lower elapsed time. Thus the client is configured to send pipelined HTTP GET requests in step 209 enabling to save roundtrip time. As already mentioned, an alternative for this is to incorporate a plurality of byte ranges in a request.

According to an embodiment, only part of the meta-data is requested in steps 204 and 205. Thus, the client may be configured to request at least some other parts of the meta-data later, e.g. during media-data reception phase. The client may determine which part of the meta-data is not yet received and request it simultaneously or with a separate request as it requests one or more media-data ranges (steps 207-209). The server is then configured to determine the indicated ranges in the file and then send them to the client. According to one further embodiment, the server is configured to interleave the requested meta-data and the media-data in the response, which the client is also configured to parse and separate the media-data from the meta-data.

The above-described features may be carried out for any streamable file format. Some examples of file formats that can be used are MPEG4 (MP4) file format, QuickTime format, ISO Base Media file format and 3GP file format.

The meta-data received and stored in the beginning of the session may comprise all necessary meta-data for the following media-data portions. It is also feasible to utilize a segmented file format in which media-data samples and meta-data related to said media-data samples are grouped as independent segments. These segments can be created and stored immediately after the necessary media data is captured and encoded. For more information on how to form and utilize this kind of file format with segment, a reference is made to patent application publication WO03/028293, incorporated as a reference.

For the above-mentioned file formats it is possible to play any parts of the file regardless in any desired order. The media-data portion can be deleted (removed from temporary memory) after it has been parsed in the receiving device C. Less temporary storage space is thus required as only meta-data, in the segmented approach only the file-level meta-data, needs to be maintained during the parsing of the file. If the device parsing the file also plays the multimedia file, the media-data (and the meta-data directly related to the media-data in the segmented approach) may be deleted permanently after playing it. This further reduces the amount of required memory resources.

The present invention can be implemented to the existing telecommunications devices. They all have processors and memory with which the inventive functionality may be implemented. A specific program code can cause a telecommunications device to implement at least part of the inventive functionality of a client and/or server described above when executed in a processor and may be embedded in or loaded to the device from an external storage medium or a telecommunications device. Different hardware implementations are also possible, such as a circuit made of separate logic components or one or more application-specific integrated circuits (ASIC). A combination of these techniques is also feasible.

It is obvious to those skilled in the art that as technology advances, the inventive concept can be implemented in many different ways. Therefore the invention and its embodiments are not limited to the above examples but may vary within the scope and spirit of the appended claims.

1. A method for arranging streaming or downloading a streamable file comprising meta-data and media-data over a network between a server and a client, the method comprising:
establishing a session between a client and a server,
transmitting at least part of the meta-data of the file to the client, the transmitted meta-data comprising at least locations of at least some of the media-data ranges in the file,
determining the location of the desired media-data part in the file on the basis of the received meta-data,
sending a request to the server informing the server on the media-data range that is to be transferred to the client, and
transmitting the requested media-data range to the client.

2. A method according to claim 1, the method comprising:
initiating the streaming or downloading by requesting from the server at least the part of the file informing the size of the meta-data portion,
transmitting at least the part of the file informing the size of the meta-data to the client,
determining the location of the meta-data part in the file on the basis of the received size information,
sending a request to the server informing the server on the meta-data range that is to be transferred to the client,
storing the meta-data for the streaming session, and
using the meta-data to determine the location of the desired media-data.

3. A method according to claim 2, wherein only part of the meta-data is requested in the meta-data range request, the method comprising:
requesting at least some other parts of the meta-data during media-data reception.

4. A method according to claim 3, wherein the requested meta-data and the media-data are interleaved.

5. A method according to claim 1, wherein the request is a HTTP GET request.

6. A method according to claim 4, wherein the HTTP GET request comprises one or more byte ranges corresponding to the desired one or more media-data or meta-data ranges in the file.

7. A telecommunications system comprising a server and a client, wherein
the server and the client are configured to establish a session for streaming or downloading a streamable file comprising meta-data and media-data,
the server is configured to transmit at least part of the meta-data of the file to the client, the transmitted meta-data comprising at least locations of at least some of the media-data ranges in the file,
the client is configured to determine the location of the desired media-data range in the file on the basis of the received meta-data,
the client is configured to send a request to the server informing the server on the media-data range that is to be transferred to the client, and
the server is configured to transmit the requested media-data range to the client.

8. A client for a streaming system, wherein
the client is configured to establish a session with a server for streaming or downloading a streamable file comprising meta-data and media-data,
the client is configured to receive at least part of the meta-data of the file from the server, the received meta-data comprising at least locations of at least some media-data ranges in the file,
the client is configured to determine the location of the desired media-data part in the file on the basis of the received meta-data, and
the client is configured to send a request to the server informing the server on the media-data range that is to be transferred to the client.

9. A client according to claim 8, wherein
the client is configured to request at least the part of the file informing the size of the meta-data portion in the file from the server,
the client is configured to receive at least the part of the file informing the size of the meta-data from the server,
the client is configured to determine the location of the meta-data part in the file on the basis of the received size information,
the client is configured to send a request to the server informing the server on the meta-data range that is to be transferred to the client,
the client is configured to store the meta-data for the streaming session, and
the client is configured to use the meta-data to determine the location of the desired media-data.

10. A client according to claim 9, wherein
the client is configured to request only part of the meta-data in the meta-data range request, and
the client is configured to request at least some other parts of the meta-data during media-data reception.

11. A client according to claim 10, wherein
the client is configured to parse a response from the server, wherein the requested meta-data and the media-data are interleaved.

12. A client according to claim 8, wherein the client is configured to form a HTTP GET request for requesting the meta-data or media-data range.

13. A client according to claim 12, wherein
the client is configured to add to the HTTP GET request one or more byte ranges corresponding to the desired one or more media-data or meta-data ranges in the file.

14. A client according to claim 12, wherein
the client is configured to pipeline HTTP GET requests with different media-data ranges.

15. A client according to claim 8, wherein
the client is configured to determine at least one media-data portion to be requested from file-level display and/or decoding order information in the received meta-data, and
the client is configured to determine the location of the selected media-data part in the file on the basis of the received meta-data.

16. A telecommunications device comprising a client for a streaming system wherein
the client is configured to establish a session with a server for streaming or downloading a streamable file comprising meta-data and media-data,
the client is configured to receive at least part of the meta-data of the file from the server, the received meta-data comprising at least locations of at least some media-data ranges in the file,
the client is configured to determine the location of the desired media-data part in the file on the basis of the received meta-data, and
the client is configured to send a request to the server informing the server on the media-data range that is to be transferred to the client.

17. A computer program product for controlling a telecommunications device, wherein the computer program product comprises:
program code causing the telecommunications device to establish a session with a server for streaming or downloading a streamable file comprising meta-data and media-data,
program code causing the telecommunications device to receive at least part of the meta-data of the file from the server, the received meta-data comprising at least locations of media-data ranges in the file,
program code causing the telecommunications device to determine the location of the desired media-data part in the file on the basis of the received meta-data, and
program code causing the telecommunications device to send a request to the server informing the server on the media-data range that is to be transferred to the client.

18. A method according to claim 2, wherein the request comprises an HTTP GET request.

19. A client according to claim 9, wherein
the client is configured to form a HTTP GET request for requesting the meta-data or media-data range.

20. The telecommunications device as in claim 16, wherein
the client is configured to request at least the part of the file informing the size of the meta-data portion in the file from the server,
the client is configured to receive at least the part of the file informing the size of the meta-data from the server,
the client is configured to determine the location of the meta-data part in the file on the basis of the received size information,
the client is configured to send a request to the server informing the server on the meta-data range that is to be transferred to the client,
the client is configured to store the meta-data for the streaming session, and
the client is configured to use the meta-data to determine the location of the desired media-data.

21. The telecommunications device as in claim 20, wherein
the client is configured to form a HTTP GET request for requesting the meta-data or media-data range.

22. The telecommunications device as in claim 20, wherein
the client is configured to request only part of the meta-data in the meta-data range request, and
the client is configured to request at least some other parts of the meta-data during media-data reception.

23. The telecommunications device as in claim 22, wherein
the client is configured to parse a response from the server, wherein the requested meta-data and the media-data are interleaved.

24. The telecommunications device as in claim 16, wherein
the client is configured to form a HTTP GET request for requesting the meta-data or media-data range.

25. The telecommunications device as in claim 24, wherein
the client is configured to add to the HTTP GET request one or more byte ranges corresponding to the desired one or more media-data or meta-data ranges in the file.

26. The telecommunications device as in claim 24, wherein
the client is configured to pipeline HTTP GET requests with different media-data ranges.

27. The telecommunication device as in claim 16, wherein
the client is configured to determine at least one media-data portion to be requested from file-level display and/or decoding order information in the received meta-data, and
the client is configured to determine the location of the selected media-data part in the file on the basis of the received meta-data.
